(19) United States
(12) Patent Application Publication
(10) Pub. No.: US 2006/0034094 A1
(43) Pub. Date: Feb. 16, 2006

(54) Vehicular marker lamp

(75) Inventors: Kohsei Asada, Shizuoka-shi (JP); Susumu Kaneko, Shizuoka-shi (JP)

Correspondence Address: KODA & ANDROLIA, 2029 CENTURY PARK EAST, SUITE 1140, LOS ANGELES, CA, 90067, US

(73) Assignee: Koito Manufacturing Co., Ltd.

(21) Appl. No.: 11/201,393

(22) Filed: Aug. 9, 2005

(30) Foreign Application Priority Data
Aug. 11, 2004 (JP) 2004-234260

(51) Int. Cl. F21S 8/10

(52) U.S. Cl. 362/545

(57) ABSTRACT

A vehicular marker lamp including an LED, which is disposed with the optical axis in the forward direction of the lamp; and an optical member 14, whch is disposed in front of the LED for guiding light from the LED toward the front of the lamp. The optical member is formed with a lens portion, a connecting portion, and a reflective portion whch are integrated as a plate-shaped single element of a transparent resin. Light from the LED and directed to the front along the LED's optical axis is refracted by the lens portion and passes therethrough to the front of the lamp, and light deviating from the LED's optical axis passes through the connecting portion and is reflected by the reflective portion toward the front of the lamp.

### BACKGROUND OF THE INVENTION

1. Field of the Invention

The present invention relates to a vehicular marker lamp and more particularly to a vehicular marker lamp which is used as a tail lamp, a stop lamp or the like and which employs LEDs as the light source.

2. Description of the Related Art

A vehicular marker lamp that uses an LED (light-emitting diode) as its light source is already known. So as to increase the light-emitting area, this type of vehicular marker lamp uses a plurality of LEDs such that the light radiated from each LED is respectively radiated to the front lens. In the structure in which the light from the LED is simply radiated toward the front lens, if the LED is disposed such that the optical axis is in the direction of the front lens, light on the optical axis and in the surrounding vicinity is radiated toward the front lens, and light deviating from the optical axis is diffused; as a result, only a part of the diffused light is incident to the front lens. It is thus impossible to effectively use all light radiated from the LED as light radiated to the front lens.

To overcome this problem, a lamp as shown in FIG. 4 has been proposed in Japanese Patent Application Laid-Open (Kokai) No. 2000-67610 (see particularly on pages 2 to 3 and FIG. 5). In this lamp, a reflector 95 is provided in the vicinity of an LED 94, so that light radiated from the LED 94 is directly radiated to a front lens 92, and light is also reflected by the reflector 95 and then is incident to the front lens 92. Thus, in this structure, light deviating from the optical axis of the LED 94 is also utilized as radiated light. However, in this structure, a portion of light, which is among the light radiated from the LED 94 and deviates from the optical axis, is merely radiated to the bottom portion of the reflector 95 and is not utilized as light radiated toward the front lens 92.

The lap shown in FIG. 5 has been proposed to overcome the above problem (see Japanese Patent Application Laid-Open (Kokai) No. 2000-67610, particularly pages 2 to 3, and FIG. 3). In this lamp 1, a reflector 6 that is a transparent member and is formed in substantially a general bowl shape is disposed in front of an LED 5. A concave portion 6a is formed on the surface of the reflector 6 that faces the LED 5, and a reflective surface 6b and a light-guiding portion 6c are formed on the back surface side of the reflector 6. The reflective surface 6b reflects all light from the LED 5, and the light-guiding portion 6c guides at least a portion of the reflected light that is reflected by the reflective surface 6b. Furthermore a convex portion 6d is formed on the front surface side of the reflector 6 that opposes the concave portion 6a, so that the convex portion 6d guides light radiated from the LED 5 toward the front side of the lamp as a result of its convex lens effect. According to this lamp, light that is from the LED 5 and advances along the optical axis is incident to the front of the lamp from the convex portion 6d, and light deviating from the optical axis is radiated to the front of the lamp via the light-guiding portion 6c. Consequently, all light radiated from the LED 5 is utilized as radiated light, thus securing a larger light-emitting area.

In the above-described related art lamp, since the reflector 6 is in substantially a bowl shape, the light-emitting area of the LED 5 is determined based upon the open area of the reflector 6. Therefore, many LEDs 5 and reflectors 6 are required in order to increase the light-emitting area of the entire lamp. The increase in the number of parts, however, causes a higher cost of the lamp. Likewise, an improvement in the light distribution characteristic and brightness also compels the use of the plurality of LEDs 5 and reflectors 6.

### BRIEF SUMMARY OF THE INVENTION

The present invention was devised in light of the foregoing issues derived from the related art, and it is an object of the present invention to provide a vehicular lamp that has an improved light distribution characteristic and brightness while increasing the light-emitting area and reducing the number of parts.

The above object of the present invention is accomplished by a unique structure for a vehicular marker lamp that includes an LED with its optical axis disposed in the forward direction of the lamp, and an optical member for guiding light radiated from the LED toward the front of the lamp; and in the present invention,
the optical member comprises:
   a lens portion that refracts light which is radiated from the LED and advances along the optical axis, thus allowing such light to pass through the lens portion to the front of the lamp;
   a reflective portion that reflects light which is radiated from the LED and deviated from the optical axis, thus allowing such light to be reflected toward the front of the lamp; and
   a connecting portion that connects the lens portion and the reflective portion and allows light radiated from the LED and deviated from the optical axis to pass through the connecting portion to the reflective portion; and further
the lens portion, reflective portion and connecting portion are made of a transparent resin in a plate-shaped single integral unit.

In this structure of the lamp of the present invention, when light radiated from the LED is guided toward the front of the lamp, light, which is among the light radiated from the LED and advances along the optical axis, is refracted by the lens portion and passes therethrough to the front of the lamp. Moreover, light deviating from the optical axis advances to the reflective portion through the connecting portion, and then it is reflected by the reflective portion toward the front of the lamp. Therefore, all of the light radiated from the LED is evenly radiated toward the front of the lamp. Furthermore, since the constituting elements, in other words, the lens portion, reflective portion and connecting portion, are formed in a plate-shaped integrated die cast element made of a transparent resin, light radiated from the LED can be guided toward the front of the lamp in an expansive fashion. Thus, the lamp has an improved light distribution characteristic and brightness, and it has an increased light distribution area. Furthermore, it is also possible to achieve a cost reduction due to the use of less number of parts.

In the present invention, the lamp can be provided with a plurality of LEDs and a plurality of optical members that correspond to the plurality of LEDs with the optical members being formed integrally.

In this structure, since the plurality of optical members are in an integrally single unit, a reduction in the number of parts is accomplished even with the use of a plurality of LEDs.

As is evident from the above, according to the vehicular marker lamp of the present invention, the lamp has an improved light distribution characteristic and brightness; and in addition, it increases the light distribution area; and in addition, it is possible to achieve a cost reduction with the use of less number of parts.

Furthermore, according to the present invention, a reduction in the number of parts can be achieved even with the use of a plurality of LEDs.

### BRIEF DESCRIPTION OF THE DRAWINGS

FIG. 1 is a front elevational view of the vehicular marker lamp according to the present invention with a front cover attached;

FIG. 2 is a cross-sectional view taken along the line 2-2 FIG. 1;

FIG. 3 is a cross-sectional view taken along the line 3-3 in FIG. 1 with the front cover omitted;

FIG. 4 is a cross-sectional view of a conventional vehicular lamp; and.

FIG. 5 is a cross-sectional view of another conventional vehicular lamp.

### DETAILED DESCRIPTION OF THE INVENTION

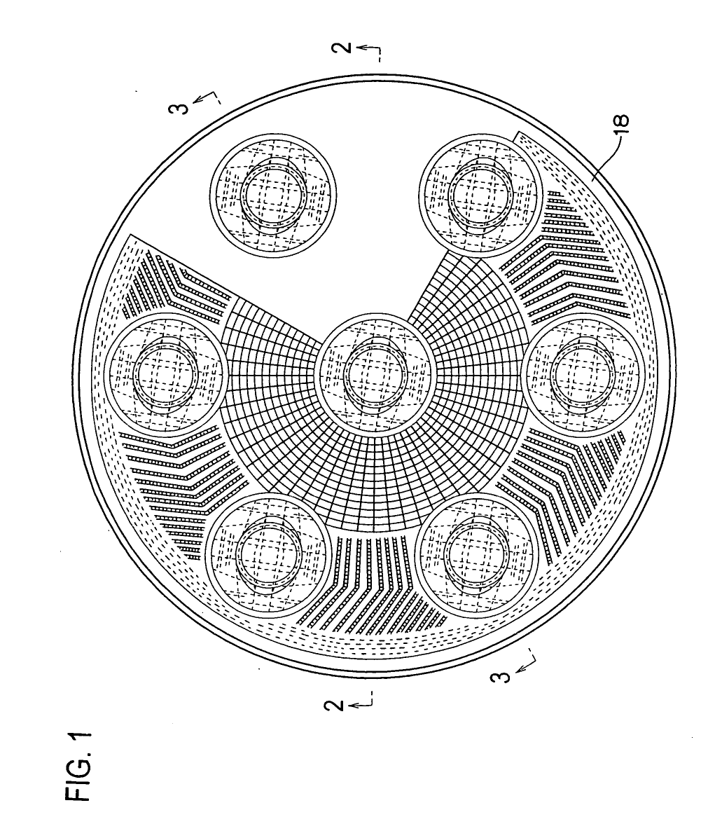

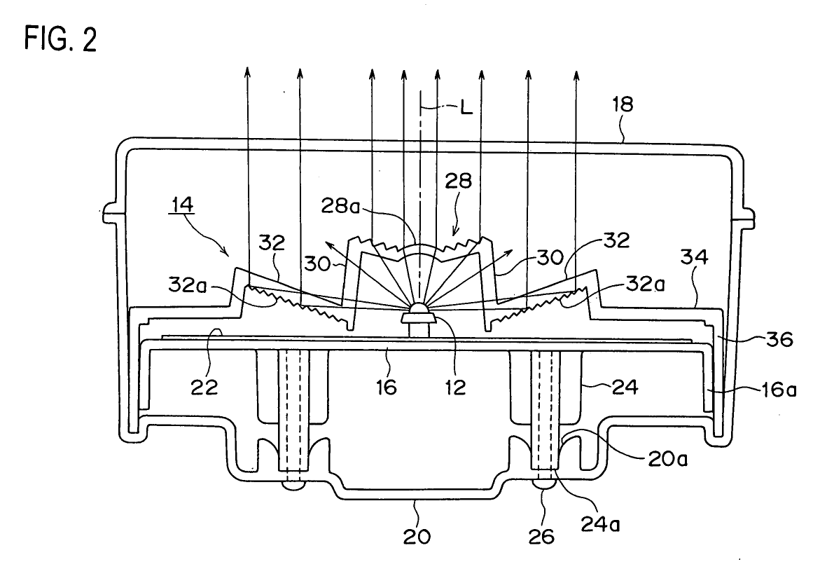

The vehicular marker lamp 10 shown in FIGS. 1 through 3 is a tail and stop lamp that is installed within a lamp mounted in the rear left comer or rear right comer of a vehicle. The lamp 10 comprises seven LEDs (light-emitting diodes) 12 that make the light source, an optical member 14 that corresponds to each LED 12, and a base member 16. The LEDs 12, along with the optical member 14, the base member 16 and the like, are accommodated within a lamp chamber that is defined by a front cover 18 formed in substantially a disc shape and a lamp body 20 formed in substantially a cylindrical shape.

The base member 16 provided corresponding to each LED 12 is a substantially disc-shaped integrated die cast element made of resin. Formed on the top surface side of the base member 16 is a bus bar 22 made of metal for connecting the terminal of each LED 12 to the light source, drive circuit (not shown) or the like; and a plurality of bosses 24 are further formed so as to protrude on the bottom surface side of the base member 16. The protruding portions 24a of the bosses 24 are inserted in the concave portions 20a of the lamp body 20 and fixed to the lamp body 20 by screws 26 that are screwed into the protruding portions 24a, so that the base member 16 is attached to the lamp body 20.

The LEDs 12 are fixed to the top surface side of the base member 16, with respective terminals thereof connected to the bus bar 22. The optical axis L of each one of the LEDs 12 is disposed in the forward direction of the lamp (or in the forward direction of the lamp chamber); in other words, the optical axis L of the LED 12 is directed toward the front of the front cover 18.

The optical members 14 provided corresponding to the LEDs 12 are formed as an integrated die cast element made of transparent resin and have a plate shape such as a disc shape. The optical member 14 guides light radiated from each of the LEDs 12 toward the front of the lamp.

More specifically, the optical member 14 is comprised of a lens portion 28, a connecting portion 30, a reflective portion 32, a connecting portion 34, and a supporting portion 36. These portions take a mutually connected structure so to form an element of a plate-shaped integrated die cast element. The supporting portion 36 is fixed to the sidewall of the lamp body 20 along with a flange 16a of the base member 16.

The lens portion 28 is disposed so that a center thereof coincides with the optical axis L of the LED 12, and a convex lens step 28a for controlling the light distribution is formed on the front surface side of the lens portion 28. The convex lens step 28a refracts light which is among the light radiated from the LED 12 and advances along the optical axis L (i.e., the convex lens step 28a refracts light in the vicinity of the optical axis L and light on the optical axis L) and allows such light to pass through to the front of the lamp.

The connecting portion 30 is in a substantially cylindrical shape and is connected to the outer peripheral portion of the lens portion 28. The connecting portion 30 allows a portion of light radiated from the LED 12 to pass therethrough to the front of the lamp and further allows light deviating from the optical axis L to pass therethrough to the reflective portion 32.

The reflective portion 32 is connected to the end portion in the axial direction of the connecting portion 34. The reflective portion 32 is formed slightly inclined with respect to a plane perpendicular to the optical axis L so that it faces the optical axis L side and the lamp front side. On the back surface side (the base member 16 side) of the reflective portion 32 is formed a reflective surface 32a. The reflective surface 32a is formed as a multi-parabolic surface of a radial shape by aluminum evaporation so that it reflects light, which is from the LED 12 and passes through the connecting portion 30, to the front of the lamp.

The outer peripheral side of the reflective portion 32 is connected to the connecting portion 34, and the outer peripheral side of the connecting portion 34 is connected to the supporting portion 36.

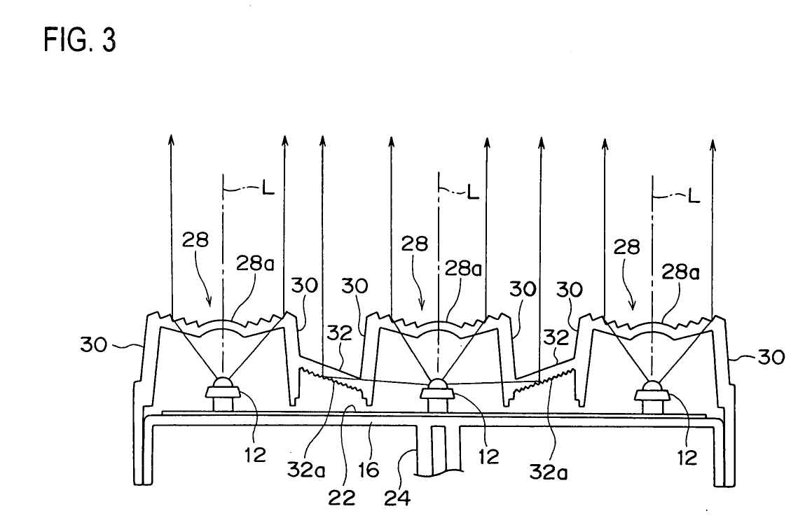

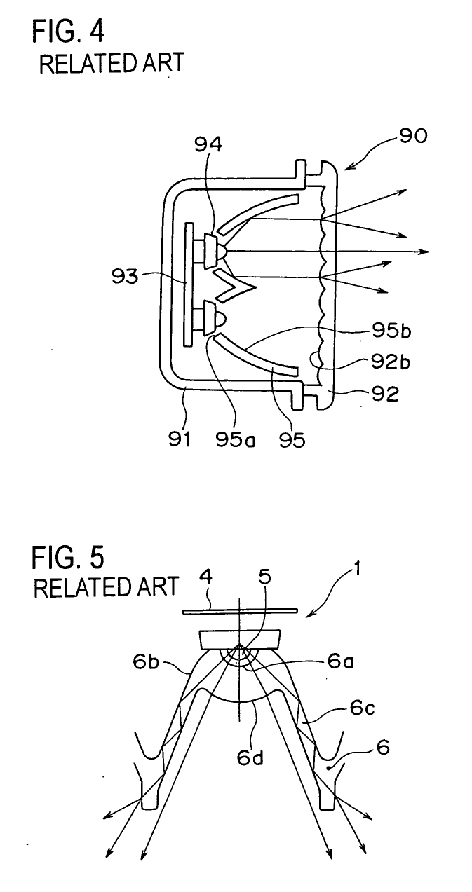

For each one of the lens portions 28 which are located on both sides of the lens portion 28 that is provided at the center of the optical member 14, the reflective portion 32 is, as seen from FIG. 3, not provided; and instead, the outer side portion of the connecting portion 30 is extended rearward, so that such an extended portion is fixed to the sidewall of the lamp body 20 along with the flange 16a of the base member 16.

When the vehicular marker lamp 10 that has the structure described above is mounted on a vehicle and is brought into a tail and stop lamp mode, light is radiated from each LED 12. Light advancing along the optical axis L is refracted by the lens portion 28, after which it passes therethrough to the front of the lamp, that is, toward the front cover 18; meanwhile, a portion of the light deviating from the optical axis L passes through the connecting portion 30 and is radiated toward the front of the lamp. The rest of light deviating from the optical axis L passes through the connecting portion 30, after which it is reflected by the reflective portion 32, and this reflected light is radiated toward the front of the lamp.

As seen from the above, in the lamp of the present invention, in order to guide light radiated from the LED 12 toward the front of the lamp, the lens portion 28, connecting portion 30, and reflective portion 32 that make the optical member 14 are used, and light from the LED is all radiated toward the front of the lamp without any loss. In addition, since the optical member 14 is made of a transparent resin and a plate-shaped integrated die cast element, light from the LED 12 is guided toward the front of the lamp in an expansive fashion, and the light distribution characteristic and brightness is improved even with the use of only seven LEDs 12 as its light source. In addition, the structure of the present invention increases the light distribution area, and it is also possible in the present invention to accomplish the cost reduction by way of the use of less number of parts.

Furthermore, since the optical members 14 that are provided corresponding to the LEDs 12 are structured as an integrated element, it is also possible to use less parts than when structuring the optical members 14 separately.

1. A vehicular marker lamp comprising an LED with an optical axis thereof disposed in a forward direction of the lamp, and an optical member for guiding light radiated from the LED toward a front of the lamp, wherein
said optical member comprises:
a lens portion that refracts light radiated from the LED and advances along the optical axis, thus allowing such light to pass through said lens portion to the front of the lamp;
a reflective portion that reflects light radiated from the LED and deviated from the optical axis, thus allowing such light to be reflected toward the front of the lamp; and
a connecting portion that connects the lens portion and the reflective portion and allows light radiated from the LED and deviated from the optical axis to pass through the connecting portion to the reflective portion; and wherein
said lens portion, reflective portion and connecting portion are made of transparent resin into a plate-shaped integrated die cast element.

2. The vehicular marker lamp according to claim 1, wherein said lamp comprises a plurality of said LEDs and a plurality of said optical members that correspond to the plurality of LEDs, said plurality of optical members being formed integrally.
